(19) United States
(12) Patent Application Publication
(10) Pub. No.: US 2025/0049024 A1
(43) Pub. Date: Feb. 13, 2025

(54) VOC COMPOSITION AND MINERAL CARRIER THEREOF

(71) Applicant: AGRIODOR, Rennes (FR)

(72) Inventor: Arcadie FUIOR, Rennes (FR)

(21) Appl. No.: 18/776,309

(22) Filed: Jul. 18, 2024

Related U.S. Application Data
(60) Provisional application No. 63/575,254, filed on Apr. 5, 2024.

(30) Foreign Application Priority Data
Jul. 18, 2023 (FR) 2307666

(51) Int. Cl. A01N 25/26; A01N 25/12; A01N 37/02; A01N 65/06; A01N 65/08; A01N 65/10; A01N 65/12; A01N 65/22; A01N 65/24; A01N 65/26; A01N 65/28; A01N 65/36; A01N 65/42; A01N 65/44; A01P 17/00; A01P 19/00

(52) U.S. Cl. CPC A01N 25/26; A01N 25/12; A01N 37/02; A01N 65/06; A01N 65/08; A01N 65/10; A01N 65/12; A01N 65/22; A01N 65/24; A01N 65/26; A01N 65/28; A01N 65/36; A01N 65/42; A01N 65/44; A01P 17/00; A01P 19/00

(57) ABSTRACT

The present technology relates to a volatile organic compound (VOC) composition repellent or attractive for insects, which comprises a mixture of VOCs and a mineral carrier. The present technology also relates to methods of using the VOC composition in agriculture, in particular in fields for protecting plants against damage caused by insect pests.

### CROSS-REFERENCE TO RELATED APPLICATIONS

This application claims the benefit of and priority to French patent application No: 2307666, filed on Jul. 18, 2023; and to U.S. provisional patent application No. 63/575,254, filed on Apr. 5, 2024; the content of both of which is herein incorporated in entirety by reference.

### FIELD OF TECHNOLOGY

The present technology relates to a volatile organic compound (VOC) composition having an effect on the behaviour of insects (repellent or attractive), which comprises at least one VOC, particularly a mixture of VOCs and a mineral carrier. The present technology further relates to methods of using the VOC composition in agriculture, in particular in fields for protecting plants against damage caused by insect pests.

### BACKGROUND INFORMATION

Protecting plants against insect pests is mainly based on the use of insecticidal molecules that have the advantage of effectively eliminating the pests, but the drawback of also eliminating other insects, such as pollinators, and forming residues that pollute the surrounding soil and water table. This is in particular the case with neonicotinoids, which act at small doses on the central nervous system of both harmful insects and pollinators.

Legislations in various countries have led to a prohibition on the use of these insecticides, but it is important to be able to provide concrete and effective alternatives to insecticides to enable farmers to produce more durably.

The use of essential oils with regard to biocontrol for agriculture is known. Essential oils of various origins have been described for their herbicidal properties (Alipour et al. 2019), Fungicides or Bactericides (Yllmaz et al., 2021; Ben-Jabeur et al. 2019; De Clerc C. et al., Foods, 2020, 9 (10), 1418) or Insecticides (Mossa T H, J.; Environmental Science and Technology, 2016, 9 (5), 354-378), including against nematodes (Nguyen, M.-H et al., Archives of Phytopathology and Plant Protection 2022, 55 (4), 420-432).

The ability of certain VOCs to attract or repel insects is known (WO 2006/040766), in particular through the use of essential oils, complex mixtures of VOCs (WO 1996/039827; Kowalska, J. et al., Molecules, 2021; Deletre et al., 2015; Obeng-Ofori et al., 1997; Araujo et al., 2012; Zhang et al., 2013) or certain mixtures that have repellent or attractive properties (WO 2016/077495; EP 3 031 322; EP 3 874 948; U.S. Pat. No. 4,880,624, WO 2004028256; WO 2011/045596; WO 2014/147110; US 2016/0302411; WO 2022/034085; Thoming G, Knudsen G K, Phytochemistry. 2014; 100:66-75; von Arx M et al., J Insect Physiol. 2011; 57 (10): 1323-31) or which induce defence mechanisms in plants liable to be attacked by insect pests (U.S. Pat. No. 8,221,736). Use thereof for repelling aphids is also described (Dardouri, Tarek et al., Agricultural and Forest Entomology, 2019; Dardouri, Tarek, et al., Pest Management Science, 2019; Dardouri et al., IOBC-WPRS Bull, 2017; Hori, Masatoshi, Journal of Chemical Ecology, 1998).

However, if the repellent or attractive properties of VOC mixtures are proven, the use thereof in fields, on a large scale, remains limited because of the constraints particular to these VOC mixtures and the mode of action thereof. At the present time there is no effective solution that allows easy application in fields, in accordance with known conventional agricultural techniques and sufficient duration of efficacy to ensure protection of the plants over several days.

It is a case of having a formulation that meets several objectives allowing this use of VOCs in agriculture, and in particular: a formulation that is simple to spread with a mechanized spreader; a diffusion kinetic that is the most “stable” and a “shelf life” of the formulation that is as long as possible (e.g., 4 to 8 weeks, at least), with a degree of diffusion of the VOCs above the target level of efficacy with a presence of all the VOCs throughout the duration of the application; and a formulation that is “resilient” to climatic events, in particular leaching, to variations in temperature and to UV radiation.

The object of the present technology is a biocontrol solution effective for use in agriculture.

### SUMMARY OF TECHNOLOGY

The present technology relates to a volatile organic compound (VOC) composition which comprises at least one VOC, particularly a mixture of VOCs, and a mineral carrier based on silica in the form of granules with a coating.

According to one embodiment, the composition is in the form of granules with a core consisting of the mineral support and the at least one VOC, particularly the VOC mixture and a coating.

The present technology also relates to the use of the VOC composition in agriculture and to methods of using the VOC composition in agriculture.

### BRIEF DESCRIPTION OF THE DRAWINGS

All features of embodiments which are described in this disclosure are not mutually exclusive and can be combined with one another. For example, elements of one embodiment can be utilized in the other embodiments without further mention. A detailed description of specific embodiments is provided herein below with reference to the accompanying drawings in which:

FIG. 1 shows the results of a study of diffusion of VOCs of granules according to the present technology in the field in a non-controlled atmosphere on a first site (Site 1) located in Eure in Normandy. The diffusion rate is given for all the VOCs in the mixture.

FIG. 2 shows the results of a study of diffusion of VOCs of granules according to the present technology in the field in a non-controlled atmosphere on a second site (Site 2) located in Loiret in Val de Loire. The diffusion rate is given for all the VOCs in the mixture.

FIG. 3 shows the results of analysis and individual measurement of diffusion of the three VOCs of the mixture on the two sites (Site 1 located in Eure in Normandy and Site 2 located in Loiret in Val de Loire); COV1: linalool, COV2: eugenol and COV3: trans-cinnamaldehyde.

FIG. 4 shows the results of the diffusion of 7 VOCs in a model VOC blend in different waxes.

### DETAILED DESCRIPTION

### Definitions

“Volatile organic compound” or “VOC” means organic compounds that evaporate at ambient temperature.

“Volatile” means having a vapour pressure greater than 0.001 kPa.

“Ambient temperature” means a temperature ranging from 15 to 40° C., more generally from 20 to 30° C.

VOCs are selected from semiochemical compounds. The semiochemical compounds could be selected from pheromones and allelochemical substances. The allelochemical substances are in particular kairomones and allomones. It may comprise negligible traces of non-volatile impurities.

“Kairomones” are VOCs produced by an emitting living organism, which produce an effect favourable for another so-called receptor living organism, when they are released into the environment.

“Allomones” are VOCs produced by individuals of a first, so-called emitting, species that cause, in the individuals of another, so-called receptor species, a favourable reaction to the emitting species.

“Pheromone” are VOCs produced by a living organism, which affect behaviour or physiology in members of the same species.

“VOC mixture” means a composition consisting of at least two VOCs. The VOC mixture may be a natural extract, a plant essential oil, or a “synthetic” or so-called “manufactured” mixture, i.e., it is not found as such in nature. It is obtained by mixing VOCs that are pure or already in mixtures with other VOCs.

The VOC and VOC mixture consists of at least 99% VOC(s), more generally 100% VOC(s). Particularly VOCs and VOC mixtures are free of components such as waxes.

“Repellent VOC” or “Repellent VOC mixture” means a VOC or VOC mixture of known composition, selected for its repellent properties vis-à-vis an insect, in particular an airborne insect.

“Attractive VOC” or “Attractive VOC mixture” means a VOC or VOC mixture of known composition, selected for its attractive properties vis-à-vis an insect, in particular an airborne insect.

“Natural VOC mixture” means a VOC mixture obtained by extraction from a living organism, in particular a plant. Mixtures of natural VOCs consist mainly of essential oils.

“Synthetic VOC mixture” or so-called “manufactured”, means a VOC mixture of predetermined composition obtained by mixing VOCs that are pure or already in mixtures with other VOCs.

“Carrier” means a material enabling the at least one VOC, particularly VOC mixture to be preserved, in particular during the storage of the composition and the dosing and use thereof. The carrier is inert vis-à-vis the VOC or VOC mixture.

“Carrier suitable for use thereof in agriculture” means a carrier that is furthermore adapted for applying the repellent or attractive composition in accordance with methods that are usual in agriculture and for the release of the VOC(s) after application.

“Use in agriculture” or “usage in agriculture” means the application of the VOC composition in fields in proximity to cultivated plants, on the plants or at the roots of the plants. “In fields” means both in an open-air field and in a greenhouse. It is a case of cultivation conditions in a non-controlled atmosphere (in a field) or little controlled (in a greenhouse), only some temperature and/or humidity parameters generally being controlled.

Unless indicated to the contrary, the percentages are weight percentages.

An indication of numerical ranges by the end points is intended to include all the numbers included in this range (for example a recitation of 1 to 5 comprises 1, 1.25, 1.5, 1.75, 2, 2.45, 2.75, 3, 3.80, 4, 4.32, 4.45 and 5).

The term “approximately” is used here explicitly or not. Each quantity given in the present description refers to the given real value, and to the approximation of this given value that would be reasonably deduced on the basis of the ordinary competences of the art, including equivalents and approximations due to experimentation and/or measurement conditions for this given value. In general, the term “approximately” in the context of a given value refers to said value or to a range that is located at less than 5% from the value or from the given range, in particular by less than 1%.

### Mineral Carrier

The carrier is suitable for use thereof in agriculture, i.e., it allows the application of the repellent or attractive composition in fields in proximity to cultivated plants, or at the roots of the plants, in accordance with the usual agronomic methods.

The carrier is inert vis-à-vis the VOC or VOC mixture, i.e., it does not produce reactions with the VOC or VOCs of the mixture in a substantial manner such that the mixture would be modified during the preservation and storage of the composition.

The carrier is a mineral carrier based on silica. Among mineral carriers based on silica, mention will be made in particular of diatomaceous earth, precipitated silica, clays, lithothamnion, kaolinite and zeolites and mixtures thereof.

According to an embodiment, the mineral carrier based on silica is diatomaceous earth. Diatomaceous earth, also called diatomite, celite or kieselguhr, is a siliceous sedimentary rock of organic and fossil origin, composed of fossilized remains of diatoms.

The mineral carrier based on silica and in particular diatomaceous earth is in a powdery form with a granulometry generally between 1 and 200 μm. Advantageously, the mineral carrier has a distribution D50 of at least 5 μm, at least 6 μm, or at least 7 μm.

The mineral carrier based on silica and in particular diatomaceous earth has a specific surface area of at least 20 m²/g, at least 25 m²/g, or at least 30 m²/g. In particular, the specific surface area of the mineral carrier ranges from 20 to 60 m²/g, from 25 to 55 m²/g, 30 to 50 m²/g, or from 30 to 45 m²/g.

According to one embodiment, the mineral carrier comprises at least approximately 50% by weight diatomaceous earth, at least approximately 60%, at least approximately 70%, at least approximately 80%, at least approximately 90%, or at least approximately 95%. According to a more particular embodiment, the mineral carrier consists essentially of diatomaceous earth. The mineral carriers based on silica and in particular diatomaceous earth are commercially available, in particular sold under the name DIAMOL® by the company IMERYS as well as manufactured by companies such as Atlantic Equipment Engineers, Inc., Twin Specialties, Noah Chemicals, Barentz, EP Container Corp., Barite World etc. Various diatomaceous earth producers are in particular referenced on the website https://www.thomasnet.com/products/diatomaceous-earth-25193400-1.html.

### VOC and VOC Mixture

Any VOC or VOC mixture having attractive or repellent properties vis-à-vis insects can be used in the VOC composition according to the invention. The VOC mixtures may be natural or synthetic.

The VOCs, the formulae thereof, the effects thereof on various insects and the references to the articles that describe them are found in particular on the website https://www.pherobase.com, in particular pheromone (https://www.pherobase.com/database/compound/compounds-behav-sexnes.php, https://www.pherobase.com/database/compound/compounds-behav-relnes.php, https://www.pherobase.com/database/compound/compounds-behav-recnes.php, https://www.pherobase.com/database/compound/compounds-behav-recnes.php, https://www.pherobase.com/database/compound/compounds-behav-prenes.php, https://www.pherobase.com/database/compound/compounds-behav-posnes.php, https://www.pherobase.com/database/compound/compounds-behav-ovines.php, https://www.pherobase.com/database/compound/compounds-behav-mignes.php, https://www.pherobase.com/database/compound/compounds-behav-marnes.php, https://www.pherobase.com/database/compound/compounds-behav-copnes.php, https://www.pherobase.com/database/compound/compounds-behav-connes.php, https://www.pherobase.com/database/compound/compounds-behav-brones.php, https://www.pherobase.com/database/compound/compounds-behav-alanes.php, https://www.pherobase.com/database/compound/compounds-behav-aggnes.php, https://www.pherobase.com/database/compound/compounds-behav-prines.php, https://www.pherobase.com/database/compound/compounds-behav-speone.php, https://www.pherobase.com/database/compound/compounds-behav-tranes.php), kairomones (https://www.pherobase.com/database/compound/compounds-behav-kaines.php), allomones (https://www.pherobase.com/database/compound/compounds-behav-allnes.php), and those identified as repellent (https://www.pherobase.com/database/compound/compounds-behav-repnts.php).

VOC and VOC mixtures and the repellent or attractive action thereof on various airborne insects are in particular described in the patent applications EP 0 629 345, US 2016/0255833, WO 2021/155257 and WO 2021/041927 and in the previously cited references.

According to one embodiment, the at least one VOC in the composition is a natural VOC mixture, particularly a natural repellent VOC mixture.

Among the natural repellent VOC mixtures, mention will be made of the essential oils of rue (Ruta graveolens), thyme (Thymus vulgaris), citronella (Cymbopogon citratus) cumin (Cuminum cyminum), lavender (Lavandula x Intermedia), verbena (Verbena officinalis), geranium (Pelargonium sp), mint, in particular green mint (Mentha spicata) and peppermint (Mentha x piperita), eucalyptus, in particular lemon eucalyptus (Corymbia citriodora) and eucalyptus globulus, cedar (Cedrus libani), clove (Syzygium aromaticum), rosemary (Rosmarinus officinalis), garlic (Allium sativum), celery (Apium graveolens), juniper (Juniperus communis), nepeta (Nepeta spp), oregano (Origanum vulgare), cymbopogon (Cymbopogon citratus), pepper (Piper spp), cinnamon (Cinnamomum spp), Chinese cinnamon (Cinnamomum cassia), caraway (Carum carvi), Moldavian dragonhead (Dracocephalum moldavicum), fennel (Foeniculum vulgare), hyssop (Hyssopus officinalis), lemon balm (Melissa officinalis), basil (Ocimum basilicum), sage (Salvia spp), coriander (Coriandrum sativum), clove tree (Syzygium aromaticum), Neem tree (Azadirachta indica), French marigold (Tagetes patula) and dill (Anethum graveolens). The essential oils can be employed alone or in mixtures.

According to one embodiment, mention will be made, for repelling flea beetles, in particular for rapeseed, an essential oil selected from the essential oils of Ruta graveolens, Thymus vulgaris, Cymbopogon citratus, Cuminum cyminum, Lavandula, Verbena officinalis, Pelargonium sp, Mentha spicata, Mentha x piperita, Corymbia citriodora, Cedrus libani, Syzygium aromaticum, Rosmarinus officinalis and Eucalyptus globulus, used alone or in mixtures.

According to another embodiment, mention will be made, for repelling thrips, in particular for tomatoes, the essential oils of Rosmarinus officinalis, Allium sativum, Apium graveolens, Juniperus virgiana, Mentha spicata, Nepeta Cataria, Litsea cubeta, Satureja montana, Thymus vulgaris, Thymus serpyllum, Origanum compactum, Cymbopogon schoenanthus, Piper nigrum, Cinnamorum verum, Cinnamomom cassia and Origanum majorata, used alone or in mixtures.

According to another embodiment, mention will be made, for repelling aphids, in particular for beetroot and bell peppers, the essential oils of Carum carvi, Citrus sinensis (L.) Osbeck, Dracocephalum kotschyi, Eucalyptus globulus Labill., Foeniculum vulgare Mill, Hyssopus officinalis, Lavandula angustifolia, Melissa officinalis L, Mentha piperita, Mentha pulegium Mill., Ocimum basilicum L, Majorana hortensis L., Origanum vulgare, Pimpinella anisum, Thymus capitatus, Verbena officinalis L, Hemizygia petiolata, Melissa officinalis, Salvia officinalis, Coriandrum sativum, Cinnamomum verum, Syzygium aromaticum, Azadirachta indica, Tagetes erecta, Allium sativum and Ruta graveolens, used alone or in mixtures.

According to yet another embodiment, mention will be made, for repelling the green pea aphid, the essential oils of Cinnamomum cassia, Mentha x piperita) Pimpinella anisum, Ocimum basilicum, Mentha spicata, Anethum graveolens, used alone or in mixtures.

A person skilled in the art will be able to select, as a VOC mixture having an effect on the behaviour of insects used according to the invention, the essential oil with respect to the airborne insect pest targeted, in particular according to the combinations of plants and airborne insect pests described previously.

According to one embodiment, the at least one VOC in the composition is a VOC or a synthetic VOC mixture.

If it is possible to envisage the use of a single VOC as “VOC mixture”, the literature teaches better efficacy of mixtures that comprise at least two different VOCs. However, a VOC composition according to the present technology encompasses compositions comprising one single VOC or mixture of at least two VOCs. Indeed, for their use in agriculture when at least two VOCs are used in combination for their beneficial effect, they can be delivered either by the provision of at least two compositions, each having one single VOC, or by one composition comprising the mixture of at least two VOCs. Advantageously, the synthetic mixture comprises from 2 to 5 different VOCs, 2, 3, 4 or 5 different VOCs, the proportions of which will vary according to the targeted insect.

The VOCs used as single VOC or in the synthetic mixture may be of natural origin, extracts of plants in particular, or synthetic. Whether they are of natural or synthetic origin, the VOCs used in the mixture according to the present technology have a purity of at least 95%, at least 96%, at least 97%, at least 98%, or at least 99%.

VOCs in the composition, either as single VOC or as a mixture of at least two VOCs are selected from semiochemical compounds, said semiochemical compounds being selected from pheromones and allelochemical substances.

Among the compounds known as pheromone, mention will be made in particular of (E,Z)-3,8-tetradecadienyl acetate, (E,Z)-7,9-dodecadien-1-ol, (E,Z)-7,9-dodecadienyl, acetate, (E,Z)-8,10-dodecadien-1-ol, (E,Z,Z)-3,8,11-tetradecatrienyl acetate, (Z)-10-tridecenyl acetate, (Z)-11-hexadecen-1-ol, (Z)-11-hexadecenal, (Z)-11-hexadecenyl acetate, (Z)-11-tetradecenyl acetate, (Z)-13-octadecenal, (Z)-7-dodecenyl acetate, (Z)-7-hexadecenal, (Z)-9-dodecenyl acetate, (Z)-9-hexadecenal, (Z)-9-tetradecenal, (Z)-9-tetradecenyl acetate, 11-dodecenyl acetate, dodecan-1-ol, dodecyl acetate, hexadecanal, hexadecyl acetate, tetradecan-1-ol, and tetradecyl acetate. In particular, the pheromone is selected from (Z)-11-hexadecenyl acetate, (Z)-9-tetradecenyl acetate, (Z)-9-dodecenyl acetate, (Z)-7-dodecenyl acetate and mixtures thereof.

Among the compounds known as allelochemical, mention will be made in particular of eugenol, linalool, cinnamaldehyde, in particular trans-cinnamaldehyde, geraniol, caryophyllene, para-cymene, gamma-terpinene, alpha-terpinene, alpha-phellandrene, epizingiberene, nerolidol, farnesol, geraniol, anisaldehyde, coumarin, methyl jasmonate, cis-jasmone, salicylaldehyde, alpha-pinene, eucalyptol, monoterpenoid citral, (E)-2-hexenal, limonene and carvacrol.

The at least VOC or the synthetic VOC mixture is selected among allelochemicals, and more particularly selected from limonene, caryophyllene, monoterpenoid citral, eugenol, linalool and cinnamaldehyde. In a more particular embodiment, the allelochemical, alone or in a synthetic VOC mixture is selected from limonene, caryophyllene, monoterpenoid citral and linalooleven more particularly selected from eugenol, linalool and cinnamaldehyde.

In another embodiment, the VOC mixture comprises at least one pheromone and one allelochemical as disclosed above. (Z)-11-hexadecenyl acetate, (Z)-9-tetradecenyl acetate, (Z)-9-dodecenyl acetate, (Z)-7-dodecenyl acetate will in particular be cited.

In another embodiment, the VOC in the composition is a synthetic VOC mixture as defined above and below.

According to one embodiment of the present technology, the synthetic VOC mixture is a repellent mixture for aphids.

Among the aphids that attack cultivations of these plants, mention will be made of the aphids of the genera Acyrthosiphon (Acyrthosiphon pisum, Acyrthosiphon malvae), Aphis (Aphis lambersi, Aphis spiraecola, Aphis fabae, Aphis gossypii, Aphis nastutii, Aphis craccivora, Aphis forbesi, Aphis frangulae), Aulacorthum (Aulacorthum solani, Aulacorthum circumflexum), Brachycaudus (Brachycaudus helichrysi), Brevicoryne (Brevicoryne brassicae), Cavariella (Cavariella aegopodii), Chaetosiphon (Chaetosiphon (Pentatrichopus) fragaefolii), Diuraphis (Diuraphis spp), Dysaphis (Dysaphis apifolia, Dysaphis crataegi, Dysaphis plantaginea), Hyadaphis (Hyadaphis foeniculi, Hyadaphis passerini), Lypaphis (Lipaphis erysimi), Macrosiphum (Macrosiphum euphorbiae), Megoura (Megoura viciae), Metopolophium (Metopolophium dirhodum, Metopolophium festucae), Myzus (Myzus persicae, Myzus ascalonicus, Myzus ornatus), Nazonovia (Nazonovia ribisnigrii), Neactaphis (Nearctaphis bakeri), Neotoxptera (Neotoxoptera formosana, Neotoxoptera oliveri), Rhodobium (Rhodobium porosum), Rhopalosiphoninus (Rhopalosiphoninus staphyleae, Rhopalosiphum padi, Rhopalosiphum insertum, Rhopalosiphum maidis, Rhopalosiphoninus latysiphon), Schizaphis (Schizaphis graminum), Semiaphis (Semiaphis dauci), Sipha (Sipha (Rungsia) elegans, Sipha (Rungsia) maydis), Sitobion (Sitobion avenae, Sitobion fragariae), Smynthurodes (Smynthurodes betae), Trama (Trama spp) and Therioaphis (Therioaphis trifolii).

Aphids are known to affect wide varieties of plants, in particular Apiaceae (Umbellifers), such as carrots, celery or radish, or aromatic plants such as parsley, fennel, angelica, cumin; Asteraceae, comprising oleaginous plants such as sunflower, oleaginous plants or market-gardening plants such as lettuce, chicory, endive, artichoke, salsify, scorzonera, or aromatic, medicinal or ornamental plants such as asters or chrysanthemums; brassicas (cruciferous vegetables), comprising oleaginous plants such as rapeseed, or vegetable brassicas; Chenopodiaceae such as beetroots, spinach, beet or chard; Cucurbitaceae, such as melons, marrows, courgettes, cucumbers, gherkins, pumpkins, watermelons; Fabaceae (leguminous) on farms such as soya, clover, sainfoin, alfalfa, vetch, proteinaceous peas, horse bean or lupine, market-gardening cultivation such as beans, peas, lentils or broad beans; Liliaceae (Alliaceae), such as leeks, onions, shallots, garlic or asparagus; Poaceae, including cereals, wheat, barley, oats or rye, forage grasses, orchard grass, fescue, timothy, ray grass or maize; Rosaceae, such as roses; Solanaceae such as potatoes, tomatoes, aubergines and chillies.

The synthetic VOC mixture repellent for aphids comprises at least linalool and eugenol. It preferably comprises less linalool than eugenol.

According to one embodiment, the linalool/eugenol weight ratio ranges from approximately 1/4 to approximately 2/3, approximately 2/7, approximately 1/3, approximately 3/8, approximately 2/5, approximately 3/7, approximately 4/9, approximately 1/2, approximately 5/9 or approximately 3/5. In particular, the linalool/eugenol weight ratio is between any one of these fractions, between approximately 2/7 and approximately 1/2, between approximately 1/3 and approximately 5/9, or between approximately 3/8 and approximately 3/5. According to one embodiment, the linalool/eugenol weight ratio is at least approximately 1/3, at least approximately 3/8, or at least approximately 2/5. According to another embodiment, the linalool/eugenol weight ratio is less than approximately 1/2, or less than approximately 4/9. According to another embodiment, the linalool/eugenol weight ratio ranges from approximately 3/8 to approximately 4/9. In some embodiments, the linalool/eugenol weight ratio is approximately 2/5 or approximately 3/7.

According to one embodiment, the VOC mixture comprises at least linalool, eugenol and cinnamaldehyde, in particular trans-cinnamaldehyde. The proportion of trans-cinnamaldehyde in the VOC mixture is less than or equal to the proportion of linalool+eugenol mixture, preferably less.

According to one embodiment, the trans-cinnamaldehyde/(linalool+eugenol) weight ratio ranges from approximately 2/7 to approximately 1/1.

According to one embodiment, the trans-cinnamaldehyde/(linalool+eugenol) weight ratio is approximately 1/3, approximately 3/8, approximately 2/5, approximately 3/7, approximately 4/9, approximately 1/2, approximately 5/9, approximately 3/5 or approximately 2/3.

In particular, the trans-cinnamaldehyde/(linalool+eugenol) weight ratio is between any one of these fractions, between approximately 1/3 and approximately 3/5, between approximately 3/8 and approximately 5/9, or between approximately 2/5 and approximately 1/2.

According to one embodiment, the trans-cinnamaldehyde/(linalool+eugenol) weight ratio is at least approximately 1/3, at least approximately 3/8, or at least approximately 2/5. According to another embodiment, the trans-cinnamaldehyde/(linalool+eugenol) weight ratio is less than approximately 5/9 less than approximately 1/2, or less than approximately 4/9.

According to another embodiment, the trans-cinnamaldehyde/(linalool/eugenol) weight ratio ranges from approximately 2/5 to approximately 1/2.

According to another embodiment, the trans-cinnamaldehyde/(linalool+eugenol) weight ratio is approximately 3/7.

In this definition, the quantity of linalool and of eugenol in the linalool+eugenol+trans-cinnamaldehyde mixture is preferably in a linalool/eugenol weight ratio as defined above.

The synthetic VOC mixture may comprise other VOCs selected from kairomones and allomones. Geraniol and caryophyllene will in particular be cited.

In one embodiment, the proportion of linalool and eugenol (linalool+eugenol) is at least 30% by weight of the total weight of the VOC mixture, at least 35%, 40%, 45% or 50% by weight. According to a more particular embodiment, the proportion of linalool and eugenol is at least 60% by weight of the total weight of the VOC mixture, or at least 65% to 100%.

In one embodiment, the proportion of linalool is ranging from 5% to 40% by weight of the total weight of the VOC mixture, ranging from 15% to 35% by weight of the total weight of the VOC mixture, or ranging from 15% to 25% by weight of the total weight of the VOC mixture. In one embodiment, the proportion of linalool is ranging from 5% to 20% by weight of the total weight of the VOC mixture. In one embodiment, the proportion of linalool is about 20% by weight of the total weight of the VOC mixture.

In one embodiment, the proportion of eugenol is ranging from 25% to 80% by weight of the total weight of the VOC mixture, ranging from 40% to 75% by weight of the total weight of the VOC mixture, or ranging from 45% to 55% by weight of the total weight of the VOC mixture. In one embodiment, the proportion of eugenol is ranging from 25% to 40% by weight of the total weight of the VOC mixture. In one embodiment, the proportion of eugenol is about 50% by weight of the total weight of the VOC mixture.

In one embodiment, the proportion of trans-cinnamaldehyde is at most 50% by weight of the total weight of the VOC mixture, at most 45%, 40%, 35%, 30%, 25%, 20%, 15%, 10% or 5% by weight of the VOC mixture. In one embodiment, the proportion of trans-cinnamaldehyde is about 30% by weight of the total weight of the VOC mixture. In one embodiment, the proportion of trans-cinnamaldehyde is ranging from 10% to 40% by weight of the total weight of the VOC mixture, or ranging from 25% to 35% by weight of the total weight of the VOC mixture. In one embodiment, the proportion of trans-cinnamaldehyde is ranging from 30% to 45% by weight of the total weight of the VOC mixture.

In one embodiment, the proportion of geraniol is at most 15% by weight of the total weight of the VOC mixture, at most 5%, 6%, 7%, 8%, 9%, 10%, 11%, 12%, 13%, or 14% by weight of the VOC mixture. In one embodiment, the proportion of geraniol is about 10% by weight of the total weight of the VOC mixture. In one embodiment, the proportion of geraniol is ranging from 5% to 15% by weight of the total weight of the VOC mixture, or ranging from 8% to 12% by weight of the total weight of the VOC mixture.

In one embodiment, the proportion of caryophyllene is at most 15% by weight of the total weight of the VOC mixture, at most 5%, 6%, 7%, 8%, 9%, 10%, 11%, 12%, 13%, or 14% by weight of the VOC mixture. In one embodiment, the proportion of caryophyllene is about 10% by weight of the total weight of the VOC mixture. In one embodiment, the proportion of caryophyllene is ranging from 5% to 15% by weight of the total weight of the VOC mixture, or ranging from 8% to 12% by weight of the total weight of the VOC mixture.

According to one embodiment, the VOC mixture comprises:
5 to 40% linalool, in particular 15 to 35%;
25 to 80% eugenol, in particular 40 to 75%, and
0 to 50% trans-cinnamaldehyde, in particular 10 to 40%,
the sum of a+b+c being less than or equal to 100% and the relative proportions of each constituent being defined above.

According to one embodiment, the VOC mixture comprises:
15 to 25% linalool, in particular approximately 20%,
45 to 55% eugenol, in particular approximately 50%, and
25 to 35% trans-cinnamaldehyde, in particular approximately 30%,
the sum of a+b+c being equal to 100%.

According to one embodiment, the VOC mixture comprises at least linalool, eugenol and cinnamaldehyde, in a 2/5/3 weight ratio. When the sum of a+b+c is less than 100%, the mixture comprises other VOCs, more particularly other kairomones or allomones described previously in relative quantities the addition to a+b+c of which equals 100%.

In one embodiment, the composition comprises:
5 to 20% linalool,
25 to 40% eugenol,
30 to 45% trans-cinnamaldehyde,
5 to 15% geraniol, and
5 to 15% caryophyllene;
the sum of a+b+c+d+e being equal to 100%.

### Coating

The coating is produced with any usual coating means/material used in agriculture and is selected so that it does not constitute a barrier to the diffusion of the VOCs, so that the coating is neutral vis-à-vis the diffusion of each VOC, i.e., the diffusion takes place without modifying the relative proportions of each VOC of the mixture diffused. The coating comprises a wax selected from vegetable waxes, such as candelilla wax, coconut wax, soy wax, sunflower wax, beeswax, olive wax, palm wax, rapeseed wax and mixtures thereof, more particularly comprises rapeseed wax.

### VOC Composition

The composition is in the form of granules with a core consisting of the mineral support and a at least one VOC or a VOC mixture and a coating.

The mineral carrier based on silica, in particular diatomaceous earth, is porous and the VOC or VOC mixture is absorbed in the mineral carrier.

According to one embodiment, the weight ratio of VOC mixture to mineral carrier is at least 1/5, at least 1/4, at least 2/7, at least 2/5, at least 1/2, at least 3/5 up to 3/4 or more.

According to one embodiment, the mineral carrier is saturated with a VOC mixture. The VOC mixture/mineral carrier weight ratio will depend on the support used and the specific surface area thereof. For diatomaceous earth, the VOC mixture/diatomaceous earth weight ratio is at least 3/5, from 3/5 to 3/4, or is approximately 2/3.

The granules advantageously have a granulometry of 2 to 10 mm, 2.5 to 6 mm, or of 3, 3.5, 4, 4.5, 5, or 5.5 mm. The granulometry is measured in accordance with the usual techniques for measuring the size of granules on a sieve.

The granules may be spherical or oblong in shape. In this case, the length is longer than the diameter and generally ranges from approximately 3 to approximately 6 mm, approximately 3 to approximately 5 mm, for example 3.25, 3.4, 3.5, 3.6, 3.75, 3.8, 4, 4.25, 4.5, 4.75, 4.85 or 5 mm.

The diameter and length values are given as mean values for the granules according to the present technology.

According to one embodiment, the granulometry of the granules is between 3 and 6 mm in diameter, with a distribution centred between 3.5 and 4.5 mm in diameter. One kg of granules includes between 30,000 and 50,000 grains.

According to one embodiment, the granules advantageously have a bulk density of approximately 0.50 to approximately 1.5 kg/L, approximately 0.60 to approximately 1.3 kg/L, approximately 0.70 to approximately 1.2 kg/L, approximately 0.75 to approximately 1.05 kg/L, approximately 0.80 to approximately 1 kg/L, preferably approximately 0.85 to approximately 1 kg/L, approximately 0.85 to approximately 0.95 kg/L, or approximately 0.87 to approximately 0.91 kg/L. According to one embodiment, the granules have a bulk density of approximately 0.89 kg/L. According to one embodiment, the granules have a bulk density of approximately 1.12 kg/L.

According to one embodiment, the granules advantageously have a hardness of approximately 0.50 to approximately 6 kg/cm², approximately 0.65 to approximately 6 kg/cm², approximately 0.70 to approximately 4 kg/cm², approximately 0.70 to approximately 3 kg/cm², approximately 0.70 to approximately 1 kg/cm², approximately 0.75 to approximately 0.85 kg/cm², or approximately 0.76 to approximately 0.82 kg/cm². According to one embodiment, the granules have a hardness of approximately 0.79 kg/cm².

The granules according to the present technology may be used with other compositions such as compositions comprising kairomone, allomone or pheromone.

The VOC mixture being adsorbed on the mineral carrier, the size of the granules corresponds essentially to the size of the mineral carrier granules.

The VOC composition can comprise binding compounds or coatings usual in formulating powders and granules, such as derivatives of cellulose, talc, starch, molasses, dextrins, gelatin, waxes, mineral waxes or vegetable waxes, gums, polymers or oils (vegetable, mineral, synthetic, natural, etc.). It can also comprise other additives usual in preparing powders and granules, such as dyes, preservatives, anti-foaming agents or anti-agglomerants.

According to one embodiment, the proportion of VOC in the composition is at least 5% by weight with respect to the total weight of the composition, preferably at least 10% by weight with respect to the total weight of the composition, in particular at least 6, 7, 8, 9, 10, 11, 12, 13, 14, 15 or 16% by weight. The proportion of VOC, particularly VOC mixture will generally range from 10 to 35% by weight, with respect to the total weight of the composition, from 15 to 30% by weight. According to one embodiment of the present technology with diatomaceous earth as mineral carrier, the composition comprises from 10% to 19% by weight of VOC or VOC mixture. According to one embodiment of the present technology with diatomaceous earth as mineral carrier, the composition comprises from 16 to 25% by weight of VOC, particularly VOC mixture.

According to one embodiment, the thickness of the coating is generally ranging from 0.01 to 5 mm, from 0.01 to 3 mm, from 0.01 to 1 mm, from 0.05 to 0.5 mm, from 0.05 to 0.3 mm, from 0.05 to 0.2 mm, or from 0.05 to 0.15 mm.

According to one embodiment, the proportion of the coating is generally ranging from 1 to 30% by weight, with respect to the total weight of the composition, namely VOC or VOC mixture, carrier and coating, in particular from 5 to 30% by weight, from 5 to 25% by weight, or from 10 to 20% by weight.

In particular, this proportion of the coating in the composition, namely VOC or VOC mixture, carrier and coating, is 1, 2, 3, 4, 5, 6, 7, 8, 9, 10, 11, 11, 12, 13, 14, 15, 16, 17, 18, 19, 20, 21, 22, 23, 24, 25, 26, 27, 28, 29 or 30% by weight. In particular, quantities will be cited of at least approximately 1%, approximately 2%, approximately 3%, approximately 4%, approximately 5%, approximately 6%, approximately 7%, approximately 8%, approximately 9%, or at least approximately 10% by weight.

Quantities will also be cited of less than or equal to approximately 30%, approximately 29%, approximately 28%, approximately 27%, approximately 26%, approximately 25%, approximately 24%, approximately 23% or less than or equal to approximately 22% by weight.

According to one embodiment, the VOC composition is in the form of granules with a mineral carrier comprising diatomaceous earth, a VOC or VOC mixture as defined previously and a coating of rapeseed wax.

The VOC compositions according to the present technology are prepared in accordance with the usual methods for preparing powders and granules.

The preparation comprises in particular the steps of:
impregnating the mineral carrier with the VOC or VOC mixture, in particular by spraying the carrier with the VOC(s) and/or immersing the carrier in the VOC or VOC mixture,
film-coating and/or coating the impregnated mineral carrier, and
optionally drying the impregnated mineral carrier film-coated and/or enrobed.

In particular for compositions in the form of granules, the method comprises obtaining the mineral carrier in the form of granules. The mineral carrier is generally initially in powder form, which it is necessary to granulate in accordance with usual techniques by mixing the powder with a binder until the required granulometry is obtained. It is also possible to procure granules, in particular diatomaceous earth granules.

The coating material, in particular vegetable wax, more particular rapeseed wax, is melted and sprayed onto the impregnated carrier granules, or the impregnated carrier granules are immersed in the molten material. The coating can be implemented by repeating the spraying or immersion several times.

The preparation method may comprise a drying step, in particular after film-coating of the granules.

### Methods of Using in Agriculture

The VOC composition according to the present technology is particularly appropriate for use in agriculture, in particular for repelling insect pests, distancing them from plants that it is sought to protect and in the vicinity of which or on which the VOC composition has been applied.

The present technology therefore relates to the use in agriculture of the VOC composition according to the invention, for protecting plants against damage caused by insect pests

The plants are in particular crop plants, such as farm plants or market-gardening plants. Among the plants used in agriculture, mention will be made of farm plants and market-garden plants, in particular Apiaceae (Umbellifers), such as carrots, celery or radish, or aromatic plants such as parsley, fennel, angelica, cumin; Asteraceae, comprising oleaginous plants such as sunflower, oleaginous plants or market-gardening plants such as lettuce, chicory, endive, artichoke, salsify, scorzonera, or aromatic, medicinal or ornamental plants such as asters or chrysanthemums; brassicas (cruciferous vegetables), comprising oleaginous plants such as rapeseed, or vegetable brassicas; Chenopodiaceae such as beetroots, spinach, beet or chard; Cucurbitaceae, such as melons, marrows, courgettes, cucumbers, gherkins, pumpkins, watermelons; Fabaceae (leguminous) on farms such as soya, clover, sainfoin, alfalfa, vetch, proteinaceous peas, horse bean or lupine, market-gardening cultivation such as beans, peas, lentils or broad beans; Liliaceae (Alliaceae), such as leeks, onions, shallots, garlic or asparagus; Poaceae, including cereals, wheat, barley, oats or rye, forage grasses, orchard grass, fescue, timothy, ray grass or maize; Rosaceae, such as roses; Solanaceae such as potatoes, particularly seed potatoes, tomatoes, aubergines and chillies.

Among crop plants or industrial cultivations, mention will be made in particular of maize, wheat, barley, rapeseed, beetroot and pea. Among market-gardening plants, mention will be made in particular of carrots, lettuce, leeks, chillies and tomatoes.

“Protecting plants against damage caused by insect pests” means protecting aerial parts of cultivated plants against the activities of insect pests (feeding, laying eggs). These attacks may cause on the plants defoliation, necrosis, growth delay, disease transfer (viruses, fungi), and ultimately reduction in the quality of harvest.

When the VOC or VOC mixture is repellent, the composition according to the present technology will be identified as repellent composition and will be applied in proximity to the plants to be protected, or on these plants.

“In proximity to the plant” generally means a distance between the zone of application of the repellent composition and the plant stem that will depend in particular on the surface area of the ground covered by the leaves at the development stage of the application. It ranges in particular from 0 (in contact) to approximately 80 cm

Advantageously, each plant will be close to an appropriate quantity of VOC composition.

The present technology therefore also relates to a method for protecting plants against damage caused by insect pests, said method consisting in applying, to the plant and/or on the ground in proximity to the plant, an appropriate quantity of repellent composition according to the invention.

When the repellent effect is best obtained with a mixture of VOCs rather than one single VOC, the application can be made either with one composition comprising the adequate mixture of VOCs, or by the application of two or more compositions, each comprising one or more VOCs. As an example, when the repellent effect is best obtained with a mixture or 3 VOCs, the application scheme can be the following:
Application of one composition comprising the mixture of 3 VOCs,
Application of two compositions, one comprising a first VOC and the second comprising a mixture of the two other VOCs,
Application of three compositions, each comprising one single VOC.

When applied in different VOC compositions, the application of the VOC compositions can be made sequentially or simultaneously. In the later case, the use or method of the present technology comprises a step of mixing the VOC compositions prior application.

The application is done in accordance with the usual methods employed in agriculture for spreading powders or granules on or at the roots of the plants.

According to an embodiment, the VOC composition can be spread with a self-supported spreader of the anti-snail spreader type, also referred to as a seed spreader According to one embodiment, other spreading methods, by drone or by autonomous robot, can also be envisaged.

The spreader may be coupled to a quad bike, a tractor or any other compatible motorised equipment. The VOC composition may be spread in continuous bands. The width between two spreader passes is generally between 20 and 30 m. The spreader generally spreads the granules by spraying over a width of between 10 and 15 m on each side. The spreading dose in kg/ha may be adjusted according to a ratio between speed of advance in km/hr and flow-flap opening diameter in mm. Some equipment makes it possible to adjust the rotation speed of the disc that projects the granules, which makes it possible to adjust the spreading width.

The homogeneity of spreading is improved by using a VOC composition in the form of granules. The homogeneity of spreading is even more improved by using a VOC composition having a distribution centred between 3.5 and 4.5 mm in diameter.

It can be done alone or combined with other improvement products and/or products for controlling pests and other diseases of cultivated plants. Advantageously, applying the repellent composition according to the present technology makes it possible to limit, and preferentially to avoid, the use of insecticides. The appropriate quantity of repellent composition is generally between 100 g/ha to 3 kg/ha according to the composition used.

The composition according to the present technology is applied as needed in prevention from the moment when the insects are liable to appear or in treatment after the appearance of the insects on the plants.

According to one embodiment appropriate for protecting crop plants, the composition having an effect on the behaviour of insects (repellent, attractive, etc.) is applied in preventive mode as soon as the seedlings emerge (cotyledon stage). According to the pressure exerted by the insects during the growth of the plants, the application of the repellent composition can be renewed at least once.

When the VOC or VOC mixture is an attractive VOC or mixture, the composition according to the present technology will be identified as attractive composition and will be applied distant from the plants to be protected, so as to distance the insect pests to be protected against.

According to one embodiment, the attractive composition will be applied on a cultivation plot distinct from the plants to be protected.

Cultivation plot distinct from the plants to be protected means a predetermined area of the field, or of the greenhouse, where the plants are cultivated, the surface area of which represents less than 10% of the total cultivated surface area, advantageously less than 5% of the total cultivated surface area. The cultivated plants are all treated with the attractive composition. These plants are said to be “sacrificed” to distance the insect pests from the cultivated plants to be protected.

This predetermined area may be unique or be divided into several sub-units distributed around or within the cultivated plants to be protected.

According to one embodiment, this predetermined area is located around the cultivated plants to be protected.

According to another embodiment, the predetermined area is located within the cultivated plants to be protected.

According to another embodiment, the predetermined area is located around and within the cultivated plants to be protected.

A person skilled in the art will be able to determine the predetermined area, the location thereof and the surface area thereof according to parameters particular to the planting considered and parameters particular to the cultivated surface area, and in particular the geographical configuration thereof.

According to one embodiment of the present technology, the composition is a repellent composition and the plants are sugar beets.

Diatomaceous earth is known for various uses in agriculture in relation to its absorbent properties, which cause desiccation of gastropods, and/or abrasive properties, which cause the death of crawling insects on contact therewith. The protective effect revealed for the present technology is independent on any putting of insect pests in contact with the carrier comprising diatomaceous earth. The protective effect is due to the VOC mixture of the composition, whether it be a repellent or attractive mixture, for distancing insect pests from the plants to be protected.

### EXAMPLES

The present technology will be understood more clearly on reading the following examples which illustrate the present technology non-restrictively.

### Measurement Methods of Physical Properties

### Granulometry

The granulometry is measured in accordance with the usual techniques for measuring the size of granules on a sieve.

### Bulk Density

Bulk density is determined in accordance with the following method.

A 1 L sample is taken using a dosing device. The dosing device is placed on a transparent test tube and the granules are poured into the transparent test tube. The top of this sample is levelled off using a ruler. The test tube is gently shaken so that the granules are well positioned and level. The transparent tube with the granules is placed on an electronic balance and the value is recorded. The weight of the empty transparent tube is recorded. the bulk density of the granules is determined by subtracting the weight of the empty tube from the total weight. The unit of the bulk density thus obtained is kg/L.

### Hardness

Hardness is measured using a durcimeter (the average value of 10 granules is recorded).

### Thickness of the Coating

The thickness of the coating layer is measured using a calliper (the average value of 10 granules is recorded) after the granule has been cut into two hemispheres using a scalpel.

### Equipment and Methods

Preparation of Formulations of a VOC Mixture with a Mineral Carrier Based on Silica.

VOC mixture: linalool/eugenol/trans-cinnamaldehyde, in a 2/5/3 weight ratio.

Mineral carrier Diatomaceous earth granules with a granulometry of 3 to 6 mm.

Coating: rapeseed wax

The VOC composition is prepared by immersing diatomaceous earth granules in the VOC mixture, and then the impregnated diatomaceous earth granules are coated with rapeseed wax by soaking in the rapeseed wax melted at 65° C.

The “core” of the granules consisting of diatomaceous earth granules impregnated with the VOC mixture represents 80% of the total mass of a granule. This percentage is given as a mean value measured for a set of several granules.

Granules were prepared for VOC/carrier weight ratios of 40/60, 50/50 and 60/40. Diffusion tests showed optimum diffusion for the 40/60 ratio.

The following tests are implemented with granules comprising approximately 48% diatomaceous earth, approximately 32% VOC mixture and approximately 20% rapeseed wax coating.

### Example 1—Spreading of the Granules

The granules are spread mainly with a self-supported spreader of the anti-snail spreader type, also referred to as a seed spreader. Other spreading methods, by drone or by autonomous robot, can also be envisaged.

The spreader may be coupled to a quad bike, a tractor or any other compatible motorised equipment. The granules are normally spread in continuous bands. The width between two spreader passes is generally between 20 and 30 m. The spreader spreads the granules by spraying over a width of between 10 and 15 m on each side. The spreading dose in kg/ha is adjusted according to a ratio between speed of advance in km/hr and flow-flap opening diameter in mm. Some equipment makes it possible to adjust the rotation speed of the disc that projects the granules, which makes it possible to adjust the spreading width.

The characteristics of the granules allow spreading of the granules that is as homogeneous as possible for a dose of between 3 and 10 kg/ha. The granulometry of the granules is between 3 and 6 mm in diameter, with a distribution centred between 3.5 and 4.5 mm in diameter. One kg of granules includes between 30,000 and 50,000 grains so as to allow homogeneous spreading over a width of 20 to 30 m.

### Example 2—Monitoring Diffusion of VOC in Fields

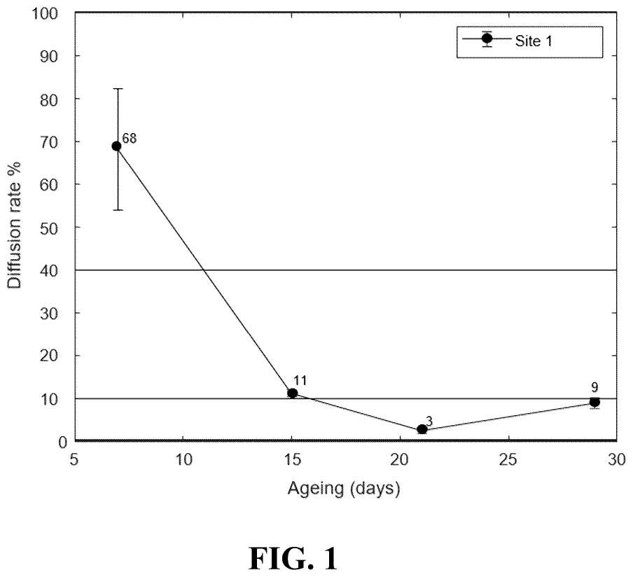

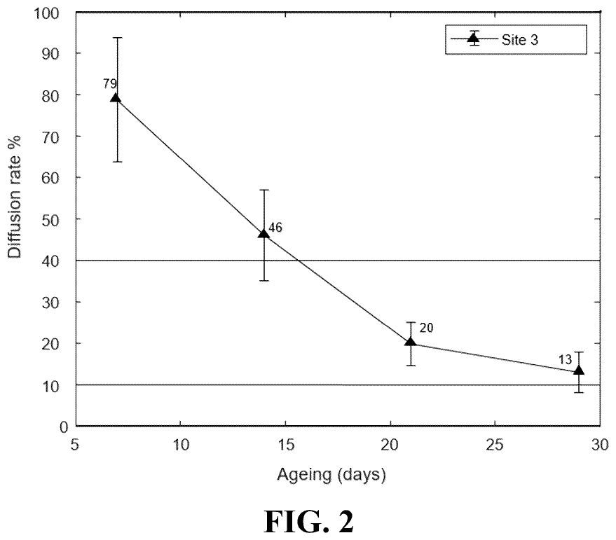

Diffusion tests in fields under non-controlled atmospheric conditions were implemented on two sites subject to different climates in terms of humidity, sunshine and wind. The first site (Site 1) (FIG. 1) is located in Eure in Normandy, and the second site (Site 2) (FIG. 2) in Loiret in Val de Loire.

### Course of Ageing Under External Conditions

So as to describe the behaviour of the granules and to quantify the diffusion levels, samples of granules were aged and analysed every week for 4 weeks. Several samples with a mass of 0.357 g of granules corresponding to the dose equivalent to 1 m² of spreading were aged in the field, on various sites. The climatic conditions (T°, rainfall, sunshine) were measured in order to correlate with the results of diffusions. Each week three replicas of samples of granules were analysed in diffusion in the laboratory in order to measure the diffusion rate.

The diffusion of VOCs of the granules was studied with the dynamic headspace technique. The granules recovered from the field are analysed in the laboratory in accordance with the protocol described below. The granules are enclosed in a closed chamber (headspace) and an airflow is circulated, which then passes through an absorbent cartridge (VOC Trap, Vassays) by means of a pump (Gilair Plus) and a flowmeter for controlling the airflow (900 ml/min) for 30 minutes. The adsorbed VOCs are eluted in a vial using pure hexane (200 μl). The liquid samples are next analysed by gas chromatography-mass spectrometry (Scion SQ GC-MS 436). The result is shown in curve or histogram form on which the change over time in the diffusion levels (expressed as %) is displayed, i.e., the concentrations of the VOCs in the air of the headspace.

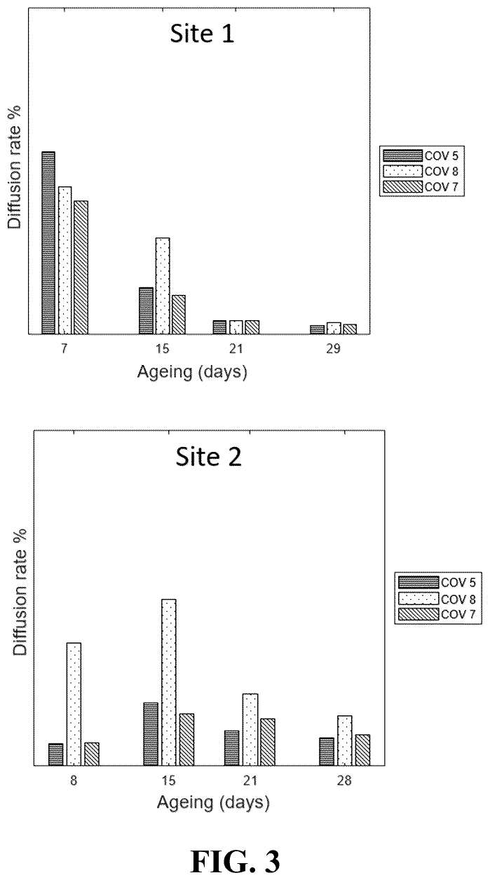

The chemical analyses (see FIG. 3) show that the three VOCs of interest are present for 28 days. The granules make it possible to have a stable diffusion of the VOCs over time.

For good efficacy in the fields, it is sought to have at least 10% diffusion rate, preferably in a range from 10% to 40% diffusion rate. It should be noted that a diffusion rate above 40% does not affect the efficacy of the composition.

The results shown on FIGS. 1 and 2 show that, under different climatic conditions, the diffusion rate is maintained above 10% for at least 15 days, ranging up to almost 30 days on Site 1 furthest south.

It can be seen, on the basis of this test, that a new application 15 days after the first ensures at least 10% diffusion rate on the site where the granules are spread.

The results shown on FIG. 3 show that, on the two sites, the three VOCs of the mixture remain present over the entire duration of the test.

### Example 3—Choice of Waxes for the Coating

11 waxes were studied for their effect on the diffusion of different VOCs in a model VOC blend comprising 7 VOCs in equal proportions (v/v): limonene, benzaldehyde, linalool, citral, eugenol, geranyl acetate and caryophyllene.

| Waxes | Melting point ° C. |
|---|---|
| Keragel 109 | 70 |
| Paraffin | 63 |
| Candelilla | 70 |
| Coco | 35 |
| Soybean | 53 |
| Soybean coco | 51 |
| Sunflower | 45 |
| Bees | 64 |
| Olive | 56 |
| Palm | 56 |
| Rapeseed | 65 |

1.78 g of the selected wax are transferred into a glass beaker. The beaker is placed in a water bath set to the temperature corresponding to the melting point of the wax used. When the wax becomes liquid, 27.8 μL of the model VOC blend are added and the mixture is homogenized using a spatula. The homogenized mixture is then transferred to a 3.5 cm diameter aluminum dish and is allowed to cool to room temperature. After cooling for 30 min to room temperature, the cup with wax impregnated with the model blend is analyzed by HSD-GC after 7 and 14 days.

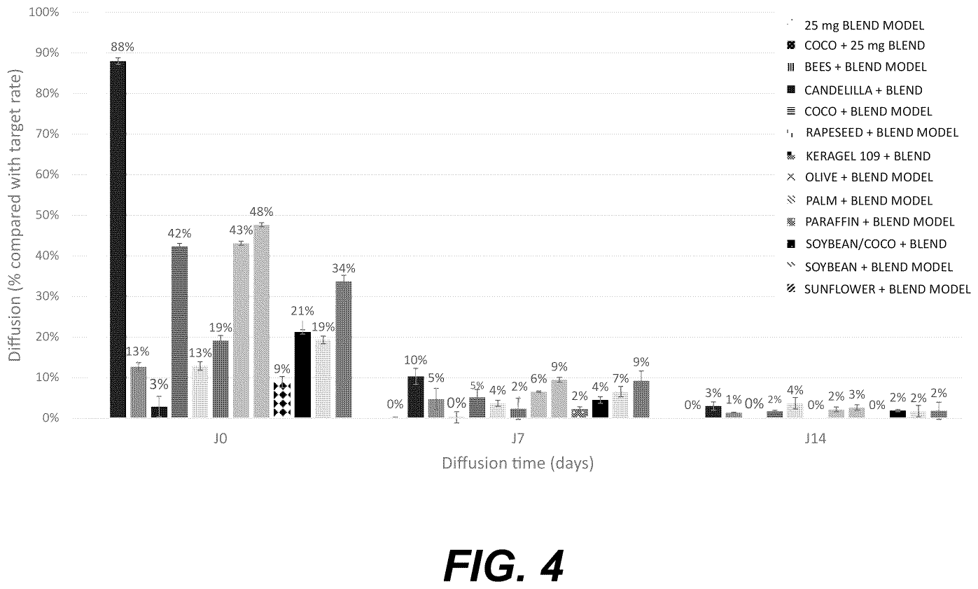

Results are presented in FIG. 4.

All references cited in this specification, and their references, are incorporated by reference herein in their entirety where appropriate for teachings of additional or alternative details, features, and/or technical background.

While the disclosure has been particularly shown and described with reference to particular embodiments, it will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A volatile organic compound (VOC) composition, comprising at least one VOC or a mixture of VOCs, and a mineral carrier based on silica, wherein the VOC composition is in the form of granules with a coating.

2. The VOC composition according to claim 1, wherein the VOC composition is in the form of granules with a core comprising the mineral carrier and the at least one VOC, and a coating.

3. The VOC composition according to claim 1, wherein the mineral carrier based on silica comprises a silica-based material selected from diatomaceous earth, precipitated silica, clays, lithothamnion, kaolinite and zeolites and mixtures thereof.

4. The VOC composition according to claim 3, wherein the mineral carrier based on silica comprises diatomaceous earth.

5. The VOC composition according to claim 1, wherein the mineral carrier is in a powdery form with a granulometry between 1 and 200 μm.

6. The VOC composition according to claim 1, wherein the mineral carrier has a distribution D50 of at least 5 μm, at least 6 μm, or at least 7 μm.

7. The VOC composition according to claim 1, wherein the mineral carrier based on silica has a specific surface area of at least 20 m²/g, at least 25 m²/g, or at least 30 m²/g.

8. The VOC composition according to claim 1, wherein the mixture of VOCs is a natural mixture, in particular selected from essential oils of rue (Ruta graveolens), thyme (Thymus vulgaris), citronella (Cymbopogon citratus) cumin (Cuminum cyminum), lavender (Lavandula x Intermedia), verbena (Verbena officinalis), geranium (Pelargonium sp), mint, in particular green mint (Mentha spicata) and peppermint (Mentha x piperita), eucalyptus, in particular lemon eucalyptus (Corymbia citriodora) and eucalyptus globulus, cedar (Cedrus libani), clove (Syzygium aromaticum), rosemary (Rosmarinus officinalis), garlic (Allium sativum), celery (Apium graveolens), juniper (Juniperus communis), nepeta (Nepeta spp), oregano (Origanum vulgare), cymbopogon (Cymbopogon citratus), pepper (Piper spp), cinnamon (Cinnamomum spp), Chinese cinnamon (Cinnamomum cassia), caraway (Carum carvi), Moldavian dragonhead (Dracocephalum moldavicum), fennel (Foeniculum vulgare), hyssop (Hyssopus officinalis), lemon balm (Melissa officinalis), basil (Ocimum basilicum), sage (Salvia spp), coriander (Coriandrum sativum), clove tree (Syzygium aromaticum), Neem tree (Azadirachta indica), French marigold (Tagetes patula) and dill (Anethum graveolens) and mixtures thereof.

9. The VOC composition according to claim 1, wherein the at least one VOC is a single VOC or a synthetic mixture.

10. The VOC composition according to claim 9, wherein the single VOC or the VOCs in the synthetic mixture are selected from semiochemical compounds, said semiochemical compounds being selected from pheromones and allelochemical VOCs.

11. The VOC composition according to claim 9, wherein the allelochemical VOC(s) are selected from eugenol, linalool, cinnamaldehyde, in particular trans-cinnamaldehyde, geraniol, caryophyllene, para-cymene, gamma-terpinene, alpha-terpinene, alpha-phellandrene, epizingiberene, nerolidol, farnesol, geraniol, anisaldehyde, coumarin, methyl jasmonate, cis-jasmone, salicylaldehyde, alpha-pinene, eucalyptol, monoterpenoide citral, (E)-2-hexenal, and carvacrol, in particular selected from eugenol, linalool and cinnamaldehyde.

12. The VOC composition according to claim 10, wherein the pheromones are selected from VOC selected from (Z)-11-hexadecenyl acetate, (Z)-9-tetradecenyl acetate, (Z)-9-dodecenyl acetate, (Z)-7-dodecenyl acetate and mixtures thereof.

13. The VOC composition according to claim 1, wherein the weight ratio of VOC mixture to mineral carrier is at least 1/5, at least 1/4, at least 2/7, at least 2/5, at least 1/2, or at least 3/5.

14. The VOC composition according to claim 1, wherein the granules have a granulometry of 2 to 10 mm.

15. The VOC composition according to claim 1, wherein the coating comprises a vegetable wax.

16. The VOC composition according to claim 15, wherein the vegetable wax is a rapeseed wax.

17. The VOC composition according to claim 1, wherein the proportion of VOC in the composition is at least 10% by weight, or is from 10 to 35% by weight, or is from 15 to 30% by weight, with respect to the total weight of the composition.

18. A method for protecting plants against damage caused by insect pests, the method comprising contacting the VOC composition of claim 1 with the plants.
